(19) United States
(12) Patent Application Publication
(10) Pub. No.: US 2012/0255973 A1
(43) Pub. Date: Oct. 11, 2012

(54) REFILLABLE CHEMICAL RESERVOIR SYSTEM FOR TRIGGER SPRAYER

(75) Inventors: James M. Schlueter, O'Fallon, MO (US); Paul E. Naslund, St. Louis, MO (US); Frederick B. Jedlicka, Jerseyville, IL (US); Kenton Marsh, Wentzville, MO (US)

(73) Assignee: DEMA ENGINEERING COMPANY, St. Louis, MO (US)

(21) Appl. No.: 13/081,200

(22) Filed: Apr. 6, 2011

(51) Int. Cl. B05B 7/04; B65B 3/04; B05B 11/00

(52) U.S. Cl. 222/136; 222/145.5; 141/59; 222/383.1; 222/144.5

(57) ABSTRACT

A chemical concentrate reservoir system for use with a hand held trigger sprayer device and a bottle reservoir includes a chemical reservoir for containing a chemical concentrate; a first adapter connected with the chemical reservoir and having a mixing chamber with at least one inlet and an outlet; wherein the bottle reservoir and the chemical reservoir are in fluid communication with the mixing chamber through said at least one inlet; a first valve at the inlet of the mixing chamber for selective control of fluid flow into said mixing chamber; and a fluid conduit connected with the outlet of the mixing chamber and with the hand held trigger sprayer device.

### TECHNICAL FIELD OF THE INVENTION

The present invention relates generally to a trigger sprayer reservoir system for containing multiple fluids, and more particularly, to a reservoir system allowing for the mixing of a diluent and a chemical concentrate within the reservoir system prior to the mixture entering and being sprayed by a standard trigger sprayer head.

### BACKGROUND OF THE INVENTION

Hand held trigger sprayers have been in use and commercially available for decades. Trigger sprayers are typically used to apply a single fluid to a surface by spraying the fluid contained within a bottle through a sprayer head. In such standard sprayer-reservoir systems, a feed tube from a trigger sprayer extends down into a bottle or reservoir. Squeezing the trigger activates a positive displacement pump and evacuates any fluid residing in the pump chamber out through a spray nozzle. Releasing the trigger creates a vacuum which draws fluid from the reservoir into the sprayer pump chamber. The liquids in such reservoirs are generally mixtures of a chemical concentrate and a diluent, such as water. Such mixtures are typically created ahead of time, and deposited within the bottle as needed.

However, as such hand held trigger sprayers are often used by cleaning or maintenance personnel, a single bottle often has insufficient capacity to hold enough of a mixture to last an entire shift. Thus, when a bottle empties, a worker must stop working and travel back to an often central location where a large amount of pre-mixed solution is kept to refill the bottle. This is an inefficient use of a worker's time.

Several sprayers have been created which are designed to hold two separate fluids, such as a chemical concentrate and a diluent (such as water), and to combine such liquids on demand via a specialized spray head. This allows workers to possess enough concentrate for an entire shift, and to refill the water diluent from readily available sources as needed.

However, such dual fluid sprayer systems are relatively complicated, and often require a complete redesign of standard trigger sprayer heads. Even previous systems which attempt to solve this problem simply, such as that shown in U.S. Pat. No. 5,439,141 to Clark et al., still require some modification to a standard sprayer head. For example, in Clark, the sleeve which press fits into the throat and creates a ball check valve arrangement must be modified or replaced to practice that invention.

Thus, there is a need for an improved sprayer reservoir system allowing for the mixing of a diluent and a chemical concentrate within the reservoir system that does not require a completely custom trigger sprayer head.

### SUMMARY OF THE INVENTION

One aspect of the invention generally pertains to refillable chemical concentrate reservoir that is able to be utilized with standard trigger sprayer heads and bottle reservoir with only minor modifications, if any, required thereto.

Another aspect of the invention pertains to a chemical concentrate reservoir for use with a trigger sprayer head that provides an enhanced method of refilling that prevents overfilling of the reservoir.

In accordance with one or more of the above aspects of the invention, there is provided a chemical concentrate reservoir system for use with a hand held trigger sprayer device and a bottle reservoir that includes a chemical reservoir for containing a chemical concentrate; a first adapter connected with the chemical reservoir and the bottle reservoir and having a mixing chamber with at least one inlet and an outlet; wherein the bottle reservoir and the chemical reservoir are in fluid communication with the mixing chamber through the at least one inlet; a first valve at the at least one inlet of the mixing chamber for selective control of fluid flow from the bottle reservoir and the chemical reservoir into the mixing chamber; and a fluid conduit connected with the outlet of the mixing chamber and with the hand held trigger sprayer device.

There is also provided a chemical concentrate reservoir system for use with a hand held trigger sprayer device and a bottle reservoir that includes a chemical reservoir for containing a chemical concentrate; a first adapter connected with the chemical reservoir and the bottle reservoir and having a mixing chamber with at least one inlet and an outlet; wherein the bottle reservoir and the chemical reservoir are in fluid communication with the mixing chamber through the at least one inlet; a first valve at the at least one inlet of the mixing chamber for selective control of fluid flow from bottle reservoir and the chemical reservoir into said mixing chamber; a fluid conduit connected with the outlet of the mixing chamber and with the hand held trigger sprayer device; and a second adapter connected between the chemical reservoir and the hand held trigger sprayer device and also connected with the fluid conduit and comprising a conduit for allowing the flow of fluid from the fluid conduit to the hand held trigger sprayer device, the second adapter also includes a filling port that is in fluid communication with the chemical reservoir.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a perspective view of a reservoir system according to a second embodiment.

FIG. 2 is a side section view of the reservoir system.

FIG. 3 is a rear section view of the reservoir system showing the trigger sprayer head and filling device to which the system is connected for filling.

FIG. 4 is a section view of the draw tube adapter of the reservoir system of FIG. 3.

FIG. 5 is a section view of the reservoir system showing the trigger sprayer head and filling device to which the system is connected for filling.

FIG. 6 is a side section view of the reservoir system showing the trigger sprayer head and filling adapter.

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

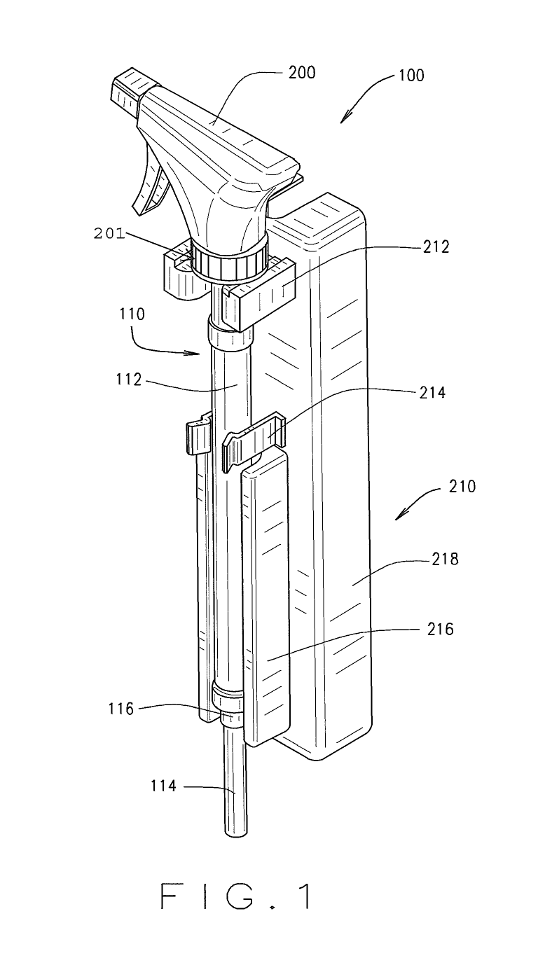

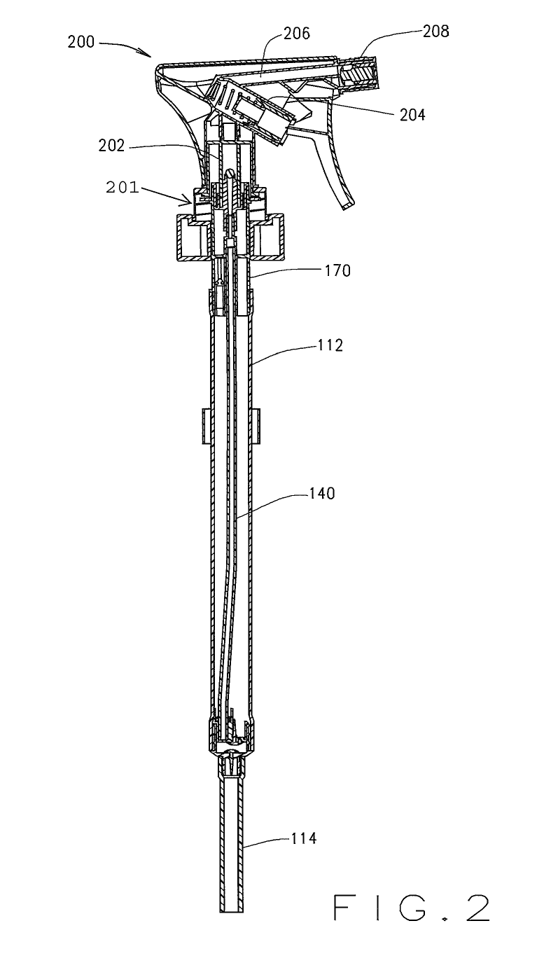

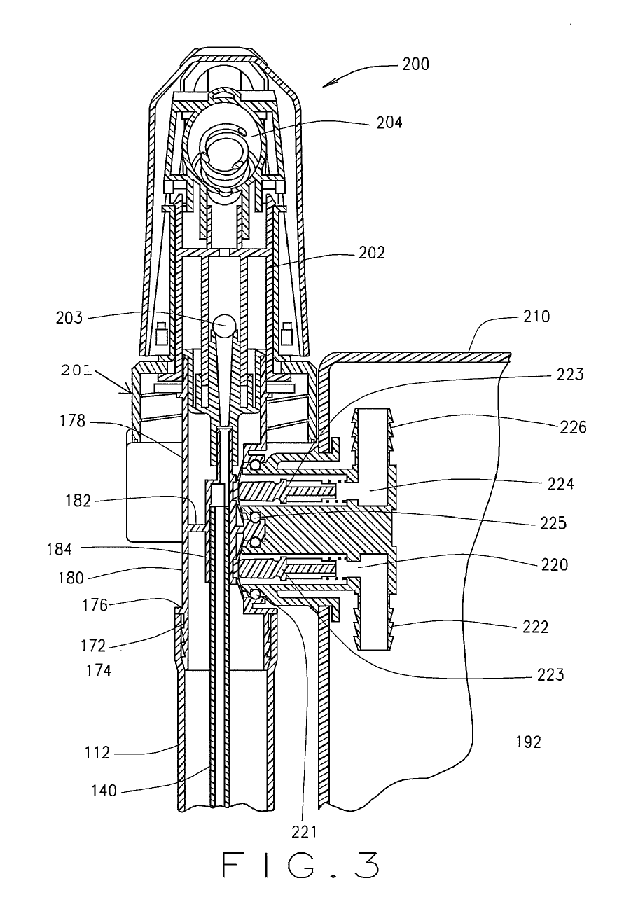

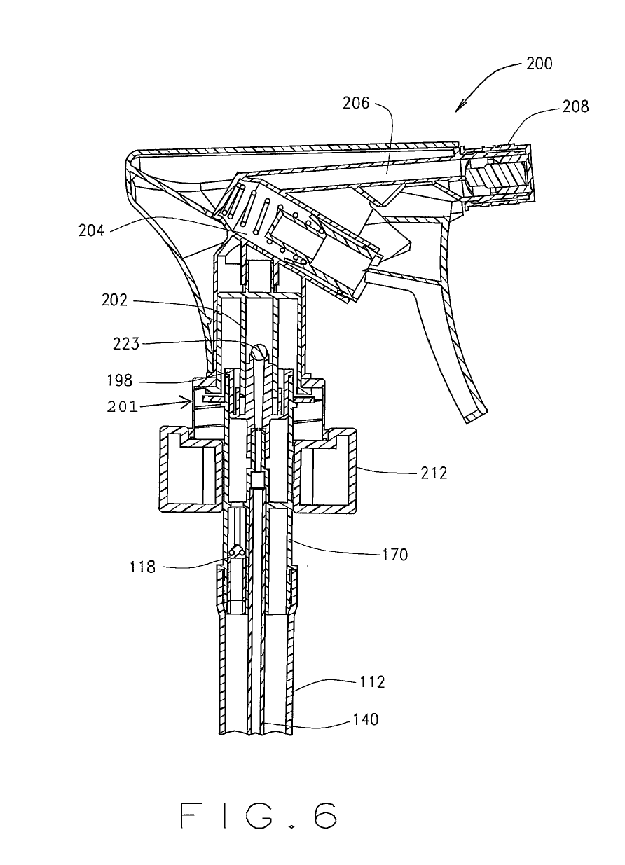

FIGS. 1-6 illustrate a refillable chemical reservoir system 100 for a trigger sprayer head 200 and bottle reservoir (not shown) containing a diluent according to a preferred embodiment of the present invention. The trigger sprayer head would be attachable to the bottle reservoir by means of a threaded neck on the bottle reservoir and a corresponding threaded collar 201 on the trigger sprayer head 200.

The system further includes a chemical reservoir 110. The chemical reservoir 110 in the illustrated embodiment is provided with an elongated, cylindrically shaped body 112. The body 112 is advantageously provided with a diameter that is at least marginally smaller than the diameter of the neck of the bottle reservoir so that the chemical reservoir 110 can be inserted through the neck of and into the bottle reservoir. The chemical reservoir 110 incorporates at its bottom end a draw tube 114 that extends toward the bottom of the bottle reservoir.

The draw tube 114 is connected with the body 112 of the chemical reservoir 110 by a draw tube adapter 116. The draw tube adapter 116 has a first male tubing nipple 118 located at its bottom end that is arranged to engage and retain one end of the draw tube 114. The adapter 116 has at its top end a second male tubing nipple 120, which in some cases may be of a larger diameter than the first tubing nipple 118, arranged to engage and retain the bottom end of the chemical reservoir body 112. A flange 122 having a diameter exceeding the inside diameter of at least the bottom end of the chemical reservoir body 112 separates the first 118 and second 120 male tubing nipples. The flange 122 also serves, in combination with a series of ridges 124 encircling the second tubing nipple 120, to seal the bottom end of the chemical reservoir body 112. Each of the ridges 124 engages in a sealing contact with the interior of the chemical reservoir body 112, while the flange 122 engages the end surface of the chemical reservoir body 112.

The adapter 116 is also provided with a longitudinal, central passage 126 extending through the length of the adapter 116. As discussed in more detail below, the adapter's central passage 126 provides a flow path, which is controlled by other elements discussed below, for diluent from the bottle reservoir, through the draw tube 114, into the mixing chamber 162.

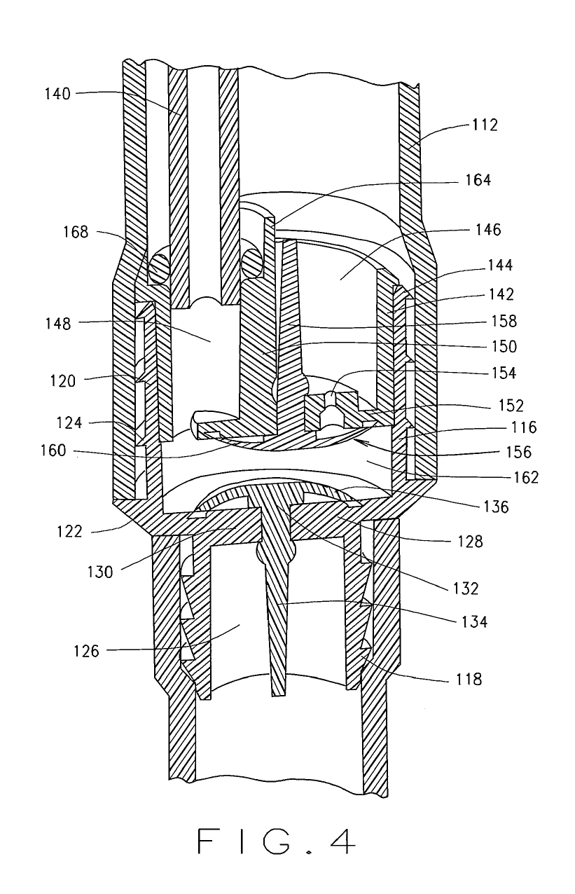

At the middle portion of the adapter 116 there is provided a segmented divider 128. The segmented divider 128 separates the adapter 116 into top and bottom sections. In the embodiment of FIG. 4, the segmented divider 128 takes the form of a circular opening that is coaxial with the central passage 126 and having a series of spokes 130 extending laterally from the edge of the circular opening toward and meeting near the middle of the circular opening. The open areas between the spokes 130 allow for the flow of diluent from the bottom section to the top section of the adapter 116.

At the center of the circular opening where the spokes 130 converge, there is provided a central orifice. This central orifice is arranged to accommodate the stem 134 of an umbrella valve 132. The stem 134 is inserted through the central orifice, which is sized to prevent flow of diluent around the valve stem 134. The valve flap 136 of the umbrella valve 132 lies over the top side of the segmented divider 128 and completely covers the open areas between the spokes 130. In a first, sealing position—to which the valve 132 is biased, the valve flap 136 lies against the top surface of the divider 128 to prevent the flow of diluent through the open areas between the spokes 130. When the valve flap 136 is raised from the top surface of the divider 128, e.g., by a lowering of ambient pressure above the valve 132, diluent can flow through the open areas between the spokes 130 and into the top section of the adapter 116.

The adapter 116 is also provided with an insert 142 positioned within the top section of the adapter 116. In the illustrated embodiment, the insert 142 slidingly engages with the top section of the adapter 116. Advantageously, the outer diameter of the insert 142 is sized to have a press fit with the interior diameter of the top section of the adapter 116 to secure the insert into place. The insert 142 has an annular flange 144 at its upper, outside edge to limit the depth of insertion of the insert 142 into the adapter 116.

The insert 142 is provided with two upwardly facing cavities. The first of these cavities 146 is in communication with and remains open to the interior of the chemical reservoir body 112. The second cavity 148 is intended to communicate with an inner draw tube 140 as described in more detail below. An interior dividing wall 150 separates the first and second cavities from one another, and a bottom wall 152 partially encloses the bottom end of the insert 142 and the cavities.

At the bottom of the first cavity 146, there is provided a metering orifice 154 in the bottom wall 152 that communicates with the first cavity 146 and allows for the flow of chemical concentrate from the chemical reservoir through the first cavity 146. Flow of chemical concentrate through the metering orifice 154 is controlled by a second umbrella valve 156. As with the first umbrella valve 132 described above, the second such valve is provided with a stem 158 and valve flap 160. The valve stem 158 is inserted into a vertical opening in the bottom wall 152 of the insert 142 to secure the valve 156 in place. The valve flap 160 is positioned to lie against the bottom surface of the bottom wall 152 and seal the metering orifice 154 in the valve's biased position. When the valve flap 160 is allowed to move away from the bottom wall 152, chemical concentrate is able to flow through the bottom wall 152 of the insert 142 via the metering orifice 154.

As can be seen most clearly in FIG. 4, there is an open area within the adapter 116 located between the bottom wall 152 of the insert 142 and the top of the segmented divider 128. This open area represents a mixing chamber 162. It is in the mixing chamber 162 that diluent flowing through the segmented divider 128 and chemical concentrate flowing through metering orifice 154 are intermingled to create the desired dispensing product. The ratios of diluent and chemical concentrate that are mixed together in the mixing chamber 162 are controlled by adjusting the size of the open areas between the spokes 130 of the segmented divider 128 and the flow area of the metering orifice 154. Alternately, or in combination with adjustment of the respective flow areas of the segmented divider 128 and metering orifice 154, the ratio of diluent and chemical concentrate can be adjusted through the use of different valve types in the segmented divider 128 and metering orifice 154 or by using valves having different performance characteristics, for example, varying durometers and/or cracking pressures.

While the illustrated embodiment makes use of umbrella valves in connection with the segmented divider 128 and metering orifice 154, those of skill in the art will recognize that other types of valves may be utilized with the present invention.

In the bottom wall 152 of the insert 142 there is provided an opening into the second cavity 148. In the illustrated embodiment, this opening remains open to the mixing chamber 162 at all times and permits the flow of mixed diluent and chemical concentrate from the mixing chamber 162 into the second cavity 148.

The chemical reservoir 110 also incorporates an inner draw tube 140 that is largely contained within the chemical reservoir body 112. The inner draw tube 140 is oriented longitudinally within the chemical reservoir body 112 and is connected at one end with the trigger sprayer 200 and at its other end with the insert 142. The inner draw tube 140 provides a conduit for the flow of a diluent/chemical mixture to the trigger sprayer 200 for dispensing.

The first cavity 148 of the insert 142 is advantageously formed to slidingly accommodate the bottom end of the inner draw tube 140. The top of the first cavity 148 is provided with the upwardly extending circular wall 164. An O-ring seal 168 is arranged to sealingly engage the outer surface of the inner draw tube 140 and prevent flow of mixed diluent/chemical concentrate around the outside of the inner draw tube 140 back into the interior of the chemical reservoir body 112. In alternate embodiments, an annular groove is provided along the interior surface of the circular wall 164 to accommodate the O-ring seal 168.

A filling adapter 170 is positioned at the top of the chemical reservoir 110. The filling adapter 170 is advantageously arranged to cooperate with a novel filling station, described in more detail below, to allow nearly automated refilling of the chemical reservoir 110 with chemical concentrate. As with many of the other components described herein, the filling adapter 170 is connected to the body 112 of the chemical reservoir by means of a nipple section 172 having a series of ridges 174 and a flange 176. Each of the ridges 174 engages in a sealing contact with the interior of the chemical reservoir body 112, while the flange 176 engages the end surface of the chemical reservoir body 112. The filling adapter is divided into a top portion 178 and a bottom portion 180, which are divided by a wall 182. The bottom portion 180 is in largely open fluid communication with the interior of the chemical reservoir body 112, while the top portion 178 is isolated from the chemical reservoir body 112 by dividing wall 182.

The filling adapter 170 includes two interior tube structures. The first is a fluid tube 184, into which the top end of the inner draw tub 140 is inserted. The fluid tube 184 passes through wall 182 and extends upwardly through the top portion 178 of the filling adapter 170. The second tube is a float check valve tube 186 and houses a float check valve 188, which is involved in the filling operation as described in more detail below. The float check valve tube 186 terminates at an orifice in wall 182, which allows selective fluid communication between the top portion 180 of the filling adapter 170 and the float check valve tube 186 as described in more detail below.

In the illustrated embodiment, the float check valve 188 is formed by a generally cylindrical valve body with a seal mounted on the top end of the valve body. The valve body has a diameter larger than that of the orifice in wall 182 but smaller than the inside diameter of the float check valve tube 186. This arrangement keeps the float check valve from passing through the orifice at the top of the float check valve tube 186. At the bottom end of the float check valve tube 186, a retainer keeps the float check valve 188 from falling out of the float check valve tube 186.

When the float check valve 188 is positioned at the top of the float check valve tube 186, the seal of the float check valve 188 engages the orifice in wall 182 to seal the orifice and prevent fluid communication from the top portion 178 of the filling adapter to the float check valve tube 186 and into the chemical reservoir body 112. As the float check valve 188 drops away from the wall 182, fluid communication is possible between the top portion 178 of the filling adapter and the interior of the chemical reservoir body 112, with fluid, including air, being able to pass through the orifice, between the valve body and the interior of the float valve check tube 186 and out the bottom end of the float valve check tube 186.

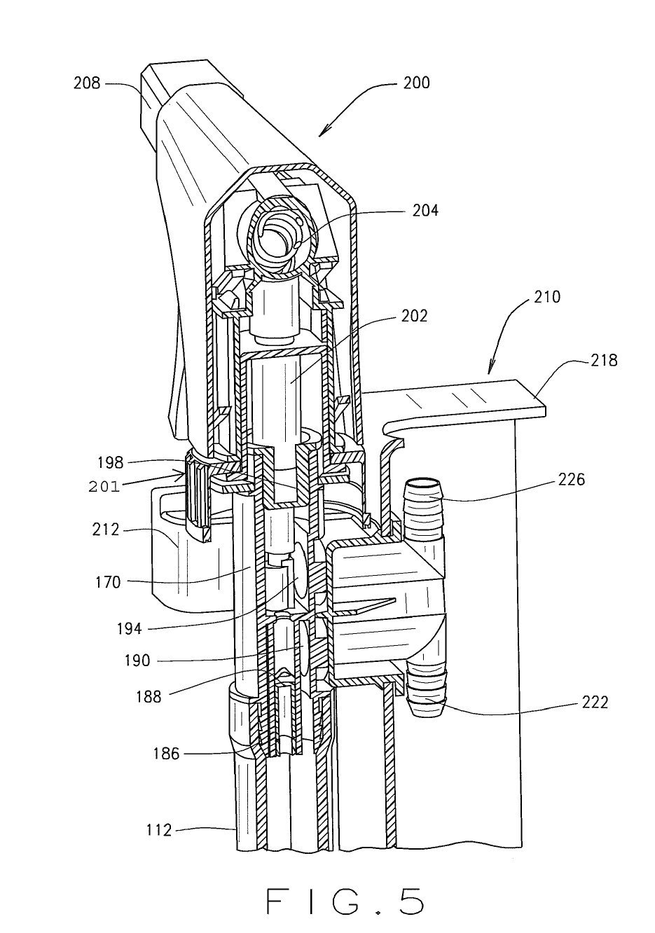

The filling adapter 170 also includes two ports in one of its exterior walls: a filling port 190 and an air port 194. In a preferred embodiment, the filling port 190 and air port 194 are arranged on the same side of the filling adapter 170, one above the other. More particularly, the air port 194 is oriented above the filling port 190. The air port 194 is positioned in the top portion 178 of the filling adapter above wall 182, while the filling port 190 is in the bottom portion 180 of the filling adapter and below wall 182. In this arrangement, the filling port 190 is in direct fluid communication with the interior of the chemical reservoir body 112. As can be seen in FIG. 5, the filling port 190 is outside of the float check valve tube 186. In one embodiment, the filling port 190 is positioned at a vertical level higher than the bottom of the float check valve tube 186. In another embodiment, the air port 194 is positioned further above the filling port 190 and in a position that places it outside of the bottle reservoir when the chemical reservoir system is inserted therein.

A trigger sprayer adapter 198 is positioned at the top of the filling adapter 170. The trigger sprayer adapter 198 is formed primarily from a cylindrical fluid passage. At its bottom end, the trigger sprayer adapter 198 is arranged to engage the top end of the fluid tube 184 of the filling adapter. At its top end, the trigger sprayer 198 engages the trigger sprayer 200. The trigger sprayer adapter 198 serves two primary purposes: it conveys the concentrate/diluent mixture from the fluid tube 184 of the filling adapter 170 to the trigger sprayer head 200; and it seals the top portion 178 of the filling adapter 170.

The trigger sprayer head 200 is of a generally conventional design utilizing a trigger actuated pump cylinder 204 and a dispensing path 206 fluidly connected with the pump cylinder and leading to a nozzle 208. The nozzle 208 may be of the spinning adjustment type or fixed. The trigger sprayer head 200 also incorporates an entry cylinder 202 to which the top end of the trigger sprayer adapter connects to fluidly connect the trigger sprayer head 200 to the inner draw tube 140 via the fluid tube 184 of the filling adapter 170. A check valve 203 in the entry cylinder 202 prevents back flow of fluid once drawn into the trigger sprayer head 200 during the compression stroke of the pump cylinder 204. The trigger sprayer head 200 operates in a known manner to draw fluid from the fluid path formed by the entry cylinder 202, trigger sprayer adapter 198, fluid tube 184, and inner draw tube 140 into the trigger sprayer head 200 during the return stroke of the trigger. During the compression stroke of the trigger, check valve 203 closes in reaction to the increase in pressure created by the stroke of the pump cylinder 204. Fluid trapped with the trigger sprayer head 200 is forced into the dispensing path 206 and out nozzle 208.

FIGS. 1, 3, and 5 illustrate a novel filling station 210 suitable for use with this embodiment of the chemical reservoir system 100. The filling station 210 is contained within a housing 218 that may be wall mounted and is arranged with supporting elements to hold one or more chemical reservoir systems 100 for the purpose of refilling the reservoirs. These supporting elements include upper supporting arms 212, lower supporting arms 216, and a securing clip 214, which keeps the chemical reservoir system in place during the refilling operation. In alternate embodiments, the securing clip 214 may be incorporating into the upper supporting arms 212. The refilling station 210 further incorporates a bulk chemical concentrate source (not shown) and a vacuum source, e.g., a pump, (also not shown) of known design. The bulk chemical concentrate source and vacuum source may be located within housing 212 or located remotely and connected by tubes, piping or similar means. Within the housing 212 is a manifold comprised of a chemical outlet 220 with a chemical nipple 222 for attachment of a tube or pipe leading from the bulk chemical concentrate source. The manifold also includes an air outlet 224 having a nipple 226 for connection to the vacuum source. The outer ends of the chemical 220 and vacuum 224 outlet paths are provided with outlet seals 221, 225 (preferably O-ring seals) that sealingly engage with the filling 190 and air 194 ports of the filling adapter 170.

When chemical reservoir system 100 is placed into the filling station 210, the filling 190 and air 194 ports of the filling adapter are aligned with the chemical 220 and air 224 outlets, respectively, of the filling station 210. Advantageously, the upper 212 and lower 216 supporting arms and securing clip 214 are arranged to position the chemical reservoir system 100 in a manner that aids the alignment of the ports of the respective components. When the outer ends of the chemical 220 and air 224 outlet paths engage the filling 190 and air 194 ports of the filling adapter 170, the filling port 192 and air port 196 check valves are pushed open to create a continuous conduit between the filling port 190 and chemical outlet 220 and between the air port 194 and the air outlet 224. Seals 221, 225 engage with the filling 190 and air 194 ports to prevent leaks during the filling process. In alternate embodiments, one or both of the chemical 220 and air 224 outlets may also be provided with check valves 223 to prevent possible back flow of fluid or air and allow for the chemical 220 and air 224 outlets to be shut off when no chemical reservoir system 100 is docked. This positive shut off feature allows multiple filling stations 210 to be connected together in series and operated from a single vacuum source and/or bulk chemical concentrate source.

Having described the structure of the illustrated embodiment, the filling and dispensing operations of the system will now be explained.

### Filling/Refilling Operation

As can be seen from the figures and above description, a reservoir is formed within the chemical reservoir body 112 for the retention of chemical concentrate in preparation for mixing with a diluent and subsequent dispensing. In order to fill or refill this reservoir with chemical concentrate, the system 100 is first placed into the filling station 210 in the manner described above. As noted above, this places the top portion 178 of the filling adapter 170 into fluid communication with the vacuum pump via the air port 194 and air outlet 224. In addition, the bottom portion 180 of the filling adapter is placed into fluid communication with the bulk chemical concentrate source via the filling port 190 and chemical outlet 220. At this point, the system 100 is ready for filling or refilling.

First, the vacuum source is activated. Activation of the vacuum source may occur manually or automatically as result of the chemical reservoir system 100 being placed into the filling station 210, for example by means of a trigger switch activated by contact with the system 100. The vacuum source acts to draw air from the reservoir through the float check valve tube 186, which is open at this stage due to the downward biasing of the float check valve 188 and the absence of any counteracting buoyant force. As air is removed from the reservoir, the pressure within the reservoir drops thereby drawing chemical concentrate from the bulk source through the chemical outlet 220 and fluid port 190 and into the reservoir.

The vacuum source continues to operate, and chemical concentrate continues to be drawn into the reservoir, until the reservoir is nearly filled. As chemical concentrate fills the reservoir and reaches the level of the float check valve 188, it forces the float check valve 188 upward until the check valve seal engages the orifice in wall 182. This disconnects the reservoir from the vacuum pump, resulting in the pressure within the reservoir equalizing. At this point, chemical concentrate ceases to be drawn from the bulk source. As can be readily seen, this particularly advantageous arrangement automatically results in complete filling of the reservoir while eliminating the possibility of overfilling and damage to the chemical reservoir system 100. It should be noted that the filling port 190 in the illustrated embodiment is advantageously arranged at a higher vertical position than the bottom of the float check valve tube 188. As the vertical positioning of the filling port 190 will directly impact the fill level of the reservoir, this higher positioning allows for more complete filling of the reservoir.

In one embodiment, the vacuum source utilized with the filling station 210 is sensitive to changes in its air intake and automatically shuts off in reaction to the increase in resistance experienced once the float check valve 188 closes. Such a system provides the added benefit of minimizing the need for operator involvement and the possibility of damage to the vacuum pump.

In an alternate embodiment, a positive pressure pump is utilized to push chemical concentrate from a bulk source into the reservoir. In such an embodiment, air within the reservoir is forced out of the reservoir through the air port as chemical concentrate fills the reservoir.

When filling is complete, the chemical reservoir system 100 may be removed from the filling station 210, whereupon the filling port check valve 192 and air port check valve 196 automatically close to seal the reservoir. The system is ready for dispensing at this point.

It should be noted that while a preferred embodiment of a filling station has been described herein, the chemical reservoir system 100 may be utilized without such a station. Further, it is possible to use variants of the described filling station. For example, a pump may be incorporated into the chemical supply path of the filling station such that fluid is pumped into the chemical reservoir, resulting in air being forced out of the chemical reservoir body through the air port instead of a vacuum pump being used.

### Mixing/Metering Operation

As previously noted, the trigger sprayer head 200 draws fluid upward from the inner draw tube 140 in a known manner through the action of the pump cylinder 204. The manner in which fluid is introduced into the inner draw tube 140 is now described. Prior to an initial dispense after refilling, chemical concentrate is stored within the chemical reservoir body 112 while diluent is stored within the bottle reservoir. The inner draw tube 140 and mixing chamber 162 are generally empty.

Upon operation of the pump cylinder 204 with a first depression of the trigger followed by the return stroke of the pump cylinder 204, air is drawn from the space in the inner draw tube 140 and mixing chamber 162, thereby reducing the pressure within this space. This reduces the pressure exerted on the surfaces of the valve flaps 136, 160 of the first and second umbrella valves 132, 156 relative to the pressure present within the bottle reservoir and the chemical reservoir, respectively, which allows the valve flaps, 136, 160 to move away from their biased closed positions. This motion opens flow paths from both the bottle reservoir and the interior of the chemical reservoir body 112—through the segmented divider 128 and metering orifice 154, respectively to allow diluent and chemical concentrate to flow into the mixing chamber 162.

As the return stroke of the pump cylinder 204 is completed, the pressure within the inner draw tube 140 and mixing chamber 165 is allowed to equalize relative to the pressure within the bottle reservoir and the chemical reservoir. This equalization of pressure forces the valve flaps 136, 160 back into their sealing positions, thereby preventing additional diluent and chemical concentrate from flowing into the mixing chamber 162 and inner draw tube 140.

With subsequent return strokes of the pump cylinder 204, mixed chemical concentrate and diluent are drawn up the inner draw tube 140 and into the trigger sprayer for dispensing through the nozzle 208 as the mixing chamber 162 is simultaneously filled with fresh chemical concentrate and diluent.

As will be appreciated by those of skill in the art, the chemical reservoir systems described herein provide a system that allows for the use of generally standard trigger sprayer components, in particular, trigger sprayer heads and reservoir, while rendering those components readily refillable with predetermined quantities of chemical concentrate. This allows for the use of bulk chemical sources while ensuring a consistently proper concentrate/diluent ratio.

The preferred embodiments of the invention have been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiments, but should be defined only in accordance with the following claims appended hereto and their equivalents.

What is claimed is:

1. A chemical concentrate reservoir system for use with a hand held trigger sprayer device and a bottle reservoir containing a diluent, comprising:
a chemical reservoir for containing a chemical concentrate, said chemical reservoir connectable with said hand held trigger sprayer device and arranged to removably fit within said bottle reservoir when said hand held trigger sprayer device is attached to said bottle reservoir;
a first adapter connected with said chemical reservoir, said first adapter comprising a mixing chamber having at least one inlet and an outlet;
wherein said bottle reservoir and said chemical reservoir are in fluid communication with said mixing chamber through said at least one inlet;
a first valve at said at least one inlet of said mixing chamber for selective control of fluid flow into said mixing chamber; and
a fluid conduit connected with said outlet of said mixing chamber and with said hand held trigger sprayer device.

2. The chemical concentrate reservoir system as set forth in claim 1, further comprising a second adapter connected between said chemical reservoir and said hand held trigger sprayer device, said second adapter being further connected with said fluid conduit and comprising an internal conduit for allowing the flow of fluid from said fluid conduit to said hand held trigger sprayer device, said second adapter further comprising a filling port, said filling port being in fluid communication with an interior of said chemical reservoir.

3. The chemical concentrate reservoir system as set forth in claim 2, wherein said second adapter further comprises an air port in fluid communication with said chemical reservoir and said filling port.

4. The chemical concentrate reservoir system as set forth in claim 3, wherein said second adapter further comprises a check valve located in a path of fluid communication between said air port and said filling port for selective obstruction of said path of fluid communication.

5. The chemical concentrate reservoir system as set forth in claim 4, where said check valve is a float check valve.

6. The chemical concentrate reservoir system as set forth in claim 1, wherein said at least one inlet comprises first and second inlets, wherein said bottle reservoir is in fluid communication with said first inlet and said chemical reservoir is in fluid communication with said second inlet and where said first valve is at said first inlet and further comprising a second valve at said second inlet.

7. The chemical concentrate reservoir system as set forth in claim 6, wherein a ratio of a total flow area of said first inlet to a total flow area of said second inlet determines a ratio of diluent to chemical concentrate flowing into said mixing chamber.

8. The chemical concentrate reservoir system as set forth in claim 6, wherein at least a first, differing characteristic of said first valve and said second valve determines a ratio of diluent to chemical concentrate flowing into said mixing chamber, and
wherein said first, differing characteristic is at least one of the group consisting of valve type, durometer, elasticity, and cracking pressure.

9. The chemical concentrate reservoir system as set forth in claim 6, wherein said second inlet comprises at least one orifice located in said first adapter, a diameter of said at least one orifice being sized to meter the amount of chemical concentrate flowing into said mixing chamber.

10. The chemical concentrate reservoir system as set forth in claim 1, wherein said fluid conduit is a tube located within said chemical reservoir.

11. The chemical concentrate reservoir system as set forth in claim 10, further comprising a second adapter connectable between said chemical reservoir and said hand held trigger sprayer device, said second adapter being further connected with said fluid conduit and comprising an internal conduit for allowing the flow of fluid from said fluid conduit to said hand held trigger sprayer device, said second adapter further comprising a filling port, said filling port being in fluid communication with an interior of said chemical reservoir; and
wherein said second adapter prevents fluid communication between said conduit and said filling port.

12. The chemical concentrate reservoir system as set forth in claim 2, further comprising a filling device, said filling device comprising a chemical passage in communication with a chemical port and an air passage in communication with an air port, said chemical passage in fluid communication with a bulk chemical concentrate source and said air passage in communication with one of the group consisting of: atmosphere and a vacuum source.

13. The chemical concentrate reservoir system as set forth in claim 12, wherein an arrangement of said filling port and said air port of said second adapter corresponds to an arrangement of said chemical port and said air port of said filling device when said chemical reservoir and said second adapter are placed in alignment with said filling device.

14. The chemical concentrate reservoir system as set forth in claim 12, wherein said filling port comprises a first port check valve and said air port comprises a second port check valve, each of said first and second port check valves being normally closed and automatically opened upon engagement of said filling port and air port of said second adapter with said chemical port and said air port, respectively, of said filling device.

15. The chemical concentrate reservoir system as set forth in claim 12, wherein said chemical passage of said filling device comprises a backflow prevention check valve.

16. The chemical concentrate reservoir system as set forth in claim 12, wherein said air passage of said filling device comprises a backflow prevention check valve.

17. A chemical concentrate reservoir system for use with a hand held trigger sprayer device and a bottle reservoir containing a diluent, comprising:
a chemical reservoir for containing a concentrate, said chemical reservoir arranged to removably fit within said bottle reservoir when said hand held trigger sprayer device is attached to said bottle reservoir;
a first adapter connected with said chemical reservoir, said first adapter comprising a mixing chamber having at least one inlet and an outlet;
wherein said bottle reservoir and said chemical reservoir are in fluid communication with said mixing chamber through said at least one inlet;
a first valve at said at least one inlet of said mixing chamber for selective control of fluid flow into said mixing chamber;
a tube within said chemical reservoir and connected with said outlet of said mixing chamber; and
a second adapter connected between said chemical reservoir and said hand held trigger sprayer device, said second adapter being further connected with said tube and comprising a conduit for allowing the flow of fluid from said tube to said hand held trigger sprayer device, said second adapter further comprising:
a filling port, said filling port being in fluid communication with an interior of said chemical reservoir; and
an air port in fluid communication with said chemical reservoir and said filling port.

18. The chemical concentrate reservoir system as set forth in claim 17, wherein said second adapter further comprises a check valve located in a fluid communication path between said air port and said filling port for selective closure of said fluid communication path.

19. The chemical concentrate reservoir system as set forth in claim 18, where said check valve is a float check valve.

20. The chemical concentrate reservoir system as set forth in claim 17, wherein said at least one inlet comprises first and second inlets, wherein said bottle reservoir is in fluid communication with said first inlet and said chemical reservoir is in fluid communication with said second inlet and where said first valve is at said first inlet and further comprising a second valve at said second inlet.

21. The chemical concentrate reservoir system as set forth in claim 20, wherein a ratio of a total flow area of said first inlet to a total flow area of said second inlet determines a ratio of diluent to chemical concentrate flowing into said mixing chamber.

22. The chemical concentrate reservoir system as set forth in claim 20, wherein at least a first, differing characteristic of said first valve and said second valve determines a ratio of diluent to chemical concentrate flowing into said mixing chamber, and
wherein said first, differing characteristic is at least one of the group consisting of valve type, durometer, elasticity, and cracking pressure.

23. The chemical concentrate reservoir system as set forth in claim 20, wherein said second inlet comprises at least one orifice located in said first adapter, a diameter of said at least one orifice being sized to meter the amount of chemical concentrate flowing into said mixing chamber.

24. The chemical concentrate reservoir system as set forth in claim 17, wherein said second adapter further comprises at least one wall preventing fluid communication between said tube and said filling port.

25. The chemical concentrate reservoir system as set forth in claim 17, further comprising a filling device, said filling device comprising a chemical passage in communication with a chemical port and an air passage in communication with an air port, said chemical passage in fluid communication with a bulk chemical concentrate source and said air passage in communication with one of the group consisting of: atmosphere and a vacuum source.

26. The chemical concentrate reservoir system as set forth in claim 25, wherein an arrangement of said filling port and said air port of said second adapter corresponds to an arrangement of said chemical port and said air port of said filling device when said chemical reservoir and said second adapter are placed in alignment with said filling device.

27. The chemical concentrate reservoir system as set forth in claim 25, wherein said filling port comprises a first port check valve and said air port comprises a second port check valve, each of said first and second port check valves being noiinally closed and automatically opened upon engagement of said filling port and air port of said second adapter with said chemical port and said air port, respectively, of said filling device.

28. The chemical concentrate reservoir system as set forth in claim 25, wherein said chemical passage of said filling device comprises a check valve.

29. The chemical concentrate reservoir system as set forth in claim 25, wherein said air passage of said filling device comprises a check valve.
